(19) United States
(12) Patent Application Publication
(10) Pub. No.: US 2003/0184849 A1
(43) Pub. Date: Oct. 2, 2003

(54) Method of distributed Raman amplification in an optical fiber

(75) Inventors: Patrice Le Roux, Villebon Sur Yvette (FR); Francois Boubal, Paris (FR); Eric Brandon, Paris (FR); Dominique Bayart, Clamart (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/403,061

(22) Filed: Apr. 1, 2003

(30) Foreign Application Priority Data
Apr. 2, 2002 (FR) 02 04 082

(51) Int. Cl. H01S 3/00

(52) U.S. Cl. 359/334

(57) ABSTRACT

In a method of optically amplifying signals between a sender station and a receiver station connected by an optical fiber, the power of a primary optical signal circulating between the sender station and the receiver station is amplified in the fiber by first order stimulated Raman scattering by first and second secondary optical pump signals having first and second wavelengths and circulating between the sender station and the receiver station, the first and second secondary signals are modulated, and at least a first tertiary optical signal having a third wavelength adapted to amplify the power of the first and second secondary signals by second order stimulated Raman scattering is transmitted in the fiber between the sender station and the receiver station.

### CROSS-REFERENCE TO RELATED APPLICATIONS

This application is based on French Patent Application No. 02 04 082 filed Apr. 2, 2002, the disclosure of which is hereby incorporated by reference thereto in its entirety, and the priority of which is hereby claimed under 35 U.S.C. §119.

### BACKGROUND OF THE INVENTION

1. Field of the Invention

The field of the invention is that of the transmission of optical signals and more particularly that of the amplification by the Raman effect of signals circulating in a fiber.

2. Description of the Prior Art

When primary optical signals circulate in an optical fiber between remote sending and receiving stations, they must generally be amplified in situ. One amplification technique used is known as first order stimulated Raman scattering (SRS). This entails circulating in the fiber, between the sending and receiving stations, in a copropagating or contrapropagating mode relative to the primary signals, first and second secondary optical signals having first and second wavelengths shorter than those of the primary signals so as to convert, by first order stimulated Raman scattering, a portion of their power (“pump power”) to the benefit of the primary signals.

If two secondary signals are used in this way in an optical fiber, they can amplify primary signals whose wavelengths are within a range of approximately 30 nanometers (nm). The efficiency of distributed Raman amplification over the whole length of the fiber is reduced firstly because of the intrinsic attenuation of the fibers, more particularly at the wavelength of the secondary signal, which reduces the distance over which the secondary signals and the primary signals interact, and secondly because of stimulated Raman scattering between the first and second secondary signals, which empties (“depletes”) the energy levels associated with the shorter wavelengths to the benefit of the energy levels associated with the longer wavelengths.

Thus an object of the invention is to solve this problem.

### SUMMARY OF THE INVENTION

To this end the invention proposes a method of optically amplifying signals between sender stations and receiver stations connected by an optical fiber, in which method the power of a primary optical signal circulating between the sender and receiver stations is amplified in the fiber by first order stimulated Raman scattering by modulated first and second secondary optical pump signals having first and second wavelengths and preferably circulating in contraflow relative to the primary signals and themselves amplified by second order stimulated Raman scattering by at least one first tertiary optical signal having a third wavelength and circulating either in contraflow relative to the primary signals or in the same direction as them.

Because the secondary signals are amplified via the tertiary signal and no longer interact much, if at all, because of the modulation, they can amplify the primary signals much more efficiently.

The modulation of the first and second secondary optical signals can apply to their respective powers or their respective wavelengths, at a chosen frequency which is preferably of the order of 10 MHz. In the case of power modulation, the powers of the first and second secondary signals can be set alternately to substantially zero.

Also, three, four or even more different secondary optical signals can be used to amplify said primary signals by first order stimulated Raman scattering, especially if the primary signals to be transmitted are distributed across a wide band of wavelengths. In this situation, it is then preferable to use two, three or even more tertiary optical signals to amplify the power of the secondary signals by second order stimulated Raman scattering.

The invention also provides a device for amplifying optical signals, including an amplifier module adapted to be connected to an optical fiber in which circulate primary optical signals capable of delivering into the optical fiber, preferably in contraflow relative to the primary signals, first and second secondary optical pump signals having first and second wavelengths adapted to amplify by first order stimulated Raman scattering the power of primary optical signals circulating in the optical fiber.

The amplifier is one in which the amplification module comprises control means capable of modulating first and second secondary signals, and sender means to deliver into the optical fiber, either in contraflow relative to the primary signals or in the same direction thereas, at least one first tertiary optical signal having a third wavelength and adapted to amplify the power of the first and second secondary signals by second order stimulated Raman scattering.

The control means are adapted to modulate the power or the wavelengths of the first or second secondary signals at a chosen frequency.

The amplification module can be adapted to deliver into the fiber, preferably in contraflow relative to the primary signals, at least one third secondary signal (“pump signal”) having a fourth wavelength and adapted to amplify the power of the primary signals by first order stimulated Raman scattering. In this case, it is advantageous for the sending means to deliver into the fiber, either in contraflow relative to the primary signals or in the same direction thereas, at least one second tertiary optical signal having a fifth wavelength and adapted to amplify the power of at least the third secondary signal by second order stimulated Raman scattering.

The invention further provides a sender station equipped with the amplifier previously cited and a receiver station equipped with the amplifier previously cited. The amplifier according to the invention can be divided between the sender and receiver stations so that the secondary signals circulate in contrapropagating mode and the tertiary signals circulate in copropagating mode relative to the primary signals.

A method, a device and sending and receiving stations according to the invention find a particularly beneficial, although not exclusive, application in the field of telecommunications, more particularly in the field of transmission systems with or without optical amplification, for example repeaters.

Other features and advantages of the invention will become apparent on reading the following detailed description and examining the accompanying drawings.

### BRIEF DESCRIPTION OF THE DRAWINGS

FIG. 1 is a diagram showing part of an installation for transmitting primary signals equipped with means for implementing an optical amplification method according to the invention.

FIG. 2 is a diagram showing an optical amplification mechanism according to the invention.

FIGS. 3A and 3B are diagrams showing one example of power modulation P as a function of time t for the first pump secondary signal λ2 and the second pump secondary signal λ3.

### DESCRIPTION OF THE PREFERRED EMBODIMENTS

The accompanying drawings are, for the most part, of a definitive kind. Consequently, they not only constitute part of the description of the invention but also and where applicable contribute to the definition of the invention.

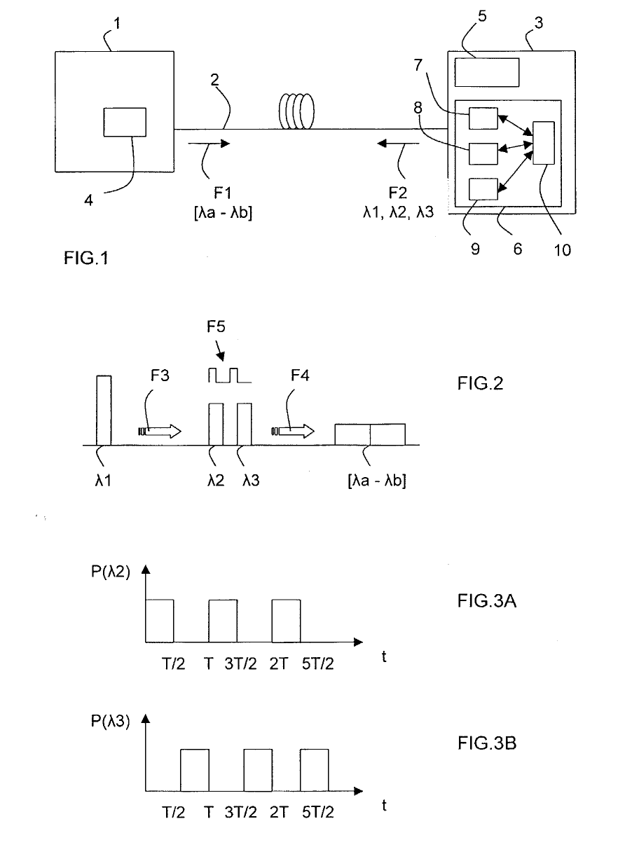

A portion of an installation for transmitting primary signals equipped with means for implementing an optical amplification method according to the invention is described first with reference to FIG. 1.

The installation includes a data transmission station 1 connected by an optical fiber 2 to a remote data receiving station 3.

In this example, the optical fiber 2 is not equipped with any optical amplifier device, such as a repeater or a signal generator, of the 3R type, for example, but the invention applies equally to fibers equipped with such devices. This kind of installation can be used in the context of undersea or terrestrial transmission, for example.

The transmitter station 1 includes a transmitter module 4 capable of delivering to the optical fiber 2 data to be transmitted in the form of optical signals referred to as primary signals having wavelengths in a chosen range [λa-λb]. For example, the primary signals sent are in the range [1 530 nm-1 562 nm].

Once sent by the transmitter module 4, the primary signals propagate in the optical fiber 2 toward the receiver station 3 (arrow F1), which includes a receiver module 5 for analyzing the primary signals received in order to use them or to forward them to one or more other stations of the installation.

Because of the distance between the sender station 1 and the receiver station 3, which is often a long distance, it is necessary to amplify the primary signals, if possible homogeneously throughout the length of the optical fiber 2, which is known as distributed amplification.

To achieve this objective, the invention provides a signal amplifier. In the example described, the amplifier is installed in the receiver station, but it could instead be installed in the sender station. Another option is for a portion of the amplifier to be installed in the sender station for sending tertiary signals and the remainder to be installed in the receiver station for sending secondary signals.

The amplifier includes an amplifier module 6 comprising three submodules 7, 8 and 9.

The first submodule 7 is adapted to deliver optical signals known as “tertiary” signals having a wavelength λ1 shorter than the wavelengths [λa-λb] of the primary signals.

The second submodule 8 is adapted to deliver first optical signals known as “secondary” signals having a wavelength λ2 shorter than the wavelengths [λa-λb] of the primary signals but longer than that (λ1) of the tertiary signals.

The third submodule 9 is adapted to deliver second optical signals known as “secondary” signals having a wavelength λ3 shorter than the wavelengths [λa-λb] of the primary signals but longer than that (λ1) of the tertiary signals and that (λ2) of the first secondary signals.

The wavelength λ1 is chosen to optimize the coupling between the tertiary signals and the first and second secondary signals, as shown in FIG. 2 (arrow F3). The expression “optimize the coupling” refers to achieving optimum amplification of the power of the secondary signals by second order stimulated Raman scattering. Second order Raman amplification provides a more homogeneous distribution of the secondary signals over the whole of the length of the fiber as well as a more homogeneous distribution of amplified spontaneous emission (ASE) noise over the whole of the length of the fiber, which locally improves the signal/noise ratio. The second order amplification mechanism is described, for example, in the paper by L.Labrunie et al. “1.6 Tbits/s (160×10 Gbits/s) unrepeatered transmission over 321 km using second order pumping Raman amplification”, and in the paper by Rottwitt et al. “Transparent 80 km bi-directionally pumped distributed Raman amplifier with second order pumping”, ECOC 99, regular paper Vol II, proceedings, p.144-145.

Because the secondary signals are amplified by the tertiary signals, the second submodule 8 and the third submodule 9 can therefore use lower power pump lasers to generate the secondary signals.

Furthermore, the wavelengths λ2 and λ3 are chosen to optimize the coupling between the secondary signals and the primary signals, as shown in FIG. 2 (arrow F4). The expression “optimize the coupling” refers to achieving optimum amplification of the power of the secondary signals by first order stimulated Raman scattering. This first order amplification mechanism is described, for example, in the paper by Aoki “Properties of fiber Raman amplifiers and their applicability to digital optical communication systems”, Journal of lightwave technology, July 1988, Vol 6, n°7.

For example, if the wavelengths [λa - λb] of the primary signals are substantially within the range [1 530 nm-1 562 nm], secondary signals can be chosen having wavelengths λ2 and λ3 respectively of approximately 1 425 nm and approximately 1 455 nm and tertiary signals having a wavelength λ1 of approximately 1 360 nm.

The three submodules 7, 8 and 9 are controlled by a control module 10 that is part of the amplifier module 6. It manages the injection of secondary and tertiary signals into the optical fiber 2. In this example, because the amplifier according to the invention is installed in the receiver station 3, injection is in contraflow relative to the primary signals (contrapropagating mode—arrow F2 in FIG. 1). However, if it were installed in the sender station 1, injection would be in the same direction as the primary signals (copropagating mode). The amplifier could equally well be in two parts, one installed in the receiver station for sending secondary signals in contrapropagating mode and the other in the sender station for sending tertiary signals in copropagating mode.

The first and second secondary signals are modulated to limit or even prohibit depopulation (depletion) of the high energy levels associated with the wavelength λ2 to the benefit of the lower energy levels associated with the wavelength λ3, which significantly reduces the efficiency of the amplification of the first signals by the first and second secondary signals through first order stimulated Raman scattering.

Modulation of the first and second secondary signals delivered by the second and third submodules 8 and 9 is controlled by the control module 10.

The modulation frequency is chosen to distribute the amplification homogeneously over the length of the optical fiber 2, because of the wavelengths chosen for the primary, secondary and tertiary signals. Accordingly, for the wavelengths specified by way of example above, the modulation frequency is preferably of the order of 10 MHz. That frequency is preferred, but others can be envisaged, for example approximately 1 MHz or approximately 100 MHz.

Two types of modulation are preferably envisaged. A first type, shown in FIGS. 3A and 3B and indicated by the arrow F5 in FIG. 2, modulates the powers of the first and second secondary signals.

Over a period T, for example, the control module 10 can authorize the second submodule 8, during the first half-period (from 0 to T/2), to deliver its first secondary signals (λ2) at a maximum power and prohibit the third submodule 9 from delivering its second secondary signals (λ3); in the second half-period (from T/2 to T), the opposite applies, and the third submodule 9 is authorized by the control module 10 to deliver its second secondary signals (λ3) at a maximum power while the second submodule 8 is prohibited from delivering its first secondary signals.

Of course, this is merely one example of power modulation. Slightly overlapping modulations of the first and second secondary signals could be envisaged, for example, or the power of one of the secondary signals could be other than totally zero when the other secondary signal is at the maximum power.

A second type of modulation, not shown, modulates the wavelengths of the first and second secondary signals. In this case the second submodule 8 may suffice, provided that it is equipped with a laser capable of delivering photons over a chosen range of wavelengths, for example from 1 425 nm to 1 455 nm. The wavelengths of the secondary signals are then modulated by periodically sweeping the range of wavelengths of the “secondary” laser of the submodule 8, controlled by the control module 10, which ensures that the secondary signals no longer interact with each other.

Of course, this is merely one example of wavelength modulation.

More complex types of modulation can be envisaged, especially if more than two second secondary signals are used, for example three or four such signals, to amplify the primary signals. In this case, as previously indicated, it is preferable to use more than one tertiary signal to amplify the secondary signals, for example two or three tertiary signals.

For example, the second submodule 8 and the third submodule 9 can be equipped with lasers capable of emitting photons at two different wavelengths (λ2-1 and λ2-2 or λ3-1 and λ3-2) to obtain first order Raman amplification of wideband primary signals using four different secondary signals.

In this case, a first mode of operation can rely on a “½” duty cycle with the submodule 8 emitting photons at two closely spaced wavelengths, like the submodule 9. It is possible for secondary signals having closely spaced wavelengths to coexist, because only interactions between “secondary” photons having widely spaced wavelengths are harmful. In this case, the control module 10 authorizes the two submodules 8 and 9 to send their secondary signals turn and turn about.

A second mode of operation can rely on a “¼” duty cycle, instead of a “½” duty cycle, so that the different wavelengths do not “see” each other at any time. This mode of operation may require higher pump laser powers.

The invention also provides a method of optical amplification of signals between a sender station 1 and a receiver station 3 connected by an optical fiber 2.

The method can be implemented using the installation described above or the amplifier, whether it is installed in a receiver station or a sender station. The main and optional functions and subfunctions of the steps of the method being substantially identical to those of the various means constituting the station, only the steps implementing the main functions of the method according to the invention are summarized hereinafter.

The method amplifies in situ (in the optical fiber), by first order stimulated Raman scattering, the power of a primary optical signal circulating between the sender station 1 and the receiver station 3 using first and second modulated pump secondary optical signals having first and second wavelengths λ2 and λ3, preferably circulating in contraflow relative to the primary signals, and themselves amplified by second order stimulated Raman scattering by at least one first tertiary optical signal λ1 having a third wavelength and circulating either in contraflow relative to or in the same direction as the primary signals.

Thanks to the method and to the amplifier according to the invention, it is possible to use a pump laser of high power or very high power to deliver the tertiary signals (λ1) for second order amplification and pump lasers of low or very low power to deliver the secondary signals (λ2 and λ3) for first order amplification of the primary signals. Because it improves the efficiency of amplification by stimulated Raman scattering, the method according to the invention can reduce the cost of the amplifier modules installed in the stations.

The invention is not limited to the embodiments of methods and stations described above by way of example only, and encompasses all variants that the person skilled in the art might envisage within the scope of the following claims.

There is claimed:

1. A method of optically amplifying signals between a sender station and a receiver station connected by an optical fiber, in which method the power of a primary optical signal circulating between said sender station and said receiver station is amplified in said fiber by first order stimulated Raman scattering by first and second secondary optical pump signals having first and second wavelengths and circulating between said sender station and said receiver station, said first and second secondary signals are modulated, and at least a first tertiary optical signal having a third wavelength adapted to amplify the power of the first and second secondary signals by second order stimulated Raman scattering is transmitted in said fiber between said sender station and said receiver station.

2. The method claimed in claim 1 wherein the power of said first and second secondary signals is modulated.

3. The method claimed in claim 2 wherein said power modulation consists of setting the powers of said first and second secondary signals substantially to zero alternately and at a chosen frequency.

4. The method claimed in claim 1 wherein the wavelengths of said first and second secondary signals are modulated at a chosen frequency.

5. The method claimed in claim 4 wherein said chosen frequency is substantially 10 MHz.

6. The method claimed in claim 1 wherein the power of said primary optical signal is amplified by first order stimulated Raman scattering by said first and second secondary optical signals and at least one third secondary pump signal having a fourth wavelength and circulating between said sender station and said receiver station.

7. The method claimed in claim 6 wherein at least one second tertiary optical signal having a fifth wavelength adapted to amplify the power of at least said third secondary signal by second order stimulated Raman scattering is transmitted.

8. The method claimed in claim 1 wherein said secondary signals circulate from said receiver station to said sender station.

9. The method claimed in claim 1 wherein said tertiary signals circulate from said receiver station to said sender station.

10. The method claimed in claim 1 wherein said tertiary signals circulate from said sender station to said receiver station.

11. A device for amplifying optical signals, including an amplifier module adapted to deliver into an optical fiber first and second secondary optical pump signals having first and second wavelengths adapted to amplify by first order stimulated Raman scattering the power of primary optical signals circulating in said optical fiber, said amplifier module including control means adapted to modulate said first and second secondary signals and sender means adapted to deliver into said fiber at least one first tertiary optical signal having a third wavelength adapted to amplify the power of the first and second secondary signals by second order stimulated Raman scattering.

12. The device claimed in claim 11 wherein said control means are adapted to modulate the power of said first and second secondary signals at a chosen frequency.

13. The device claimed in claim 11 wherein said control means are adapted to modulate the wavelengths of said first and second secondary signals at a chosen frequency.

14. The device claimed in claim 11 wherein said amplifier module is adapted to deliver into said optical fiber at least one third secondary pump signal having a fourth wavelength and adapted to amplify the power of said primary signals by first order stimulated Raman scattering.

15. The device claimed in claim 14 wherein said sender means are adapted to deliver into said optical fiber at least one second tertiary optical signal having a fifth wavelength and adapted to amplify the power of at least said third secondary signal by second order stimulated Raman scattering.

16. The device claimed in claim 11 wherein said amplifier module is adapted to deliver said secondary signals into said optical fiber in contraflow relative to said primary signals.

17. The device claimed in claim 11 wherein said amplifier module is adapted to deliver said tertiary signals into said optical fiber in contraflow relative to said primary signals.

18. The device claimed in claim 11 wherein said amplifier module is adapted to deliver said tertiary signals into said optical fiber in the same direction as said primary signals.

19. An optical signal receiver station including a receiver module adapted to be connected to a first optical fiber end to receive primary optical signals from a sender station connected to a second end of said optical fiber and a device as claimed in claim 11, said secondary and tertiary signals circulating in contraflow relative to said primary signals.

20. Application of a method as claimed in claim 1, a device as claimed in claim 11, and a receiver station as claimed in claim 19 to Raman amplification in the field of telecommunications.

21. The application claimed in claim 20 wherein said telecommunication field is that of transmission systems equipped with devices for optically amplifying signals.

22. The application claimed in claim 20 wherein said telecommunication field is that of transmission systems with no devices for optically amplifying signals.
